(19) United States
(12) Patent Application Publication
(10) Pub. No.: US 2020/0410299 A1
(43) Pub. Date: Dec. 31, 2020

(54) INCREMENTAL LEARNING METHOD THROUGH DEEP LEARNING AND SUPPORT DATA

(71) Applicant: KING ABDULLAH UNIVERSITY OF SCIENCE AND TECHNOLOGY, Thuwal (SA)

(72) Inventors: Xin GAO, Thuwal (SA); Yu LI, Thuwal (SA)

(21) Appl. No.: 16/970,021

(22) PCT Filed: Mar. 27, 2019
(86) PCT No.: PCT/IB2019/052500

§ 371 Date: Aug. 14, 2020

Related U.S. Application Data
(60) Provisional application No. 62/651,384, filed on Apr. 2, 2018.

(51) Int. Cl. G06K 9/62; G06N 3/08; G06N 20/10

(52) U.S. Cl. CPC G06K 9/6269; G06N 20/10; G06N 3/08; G06K 9/628

(57) ABSTRACT

A method for classifying data into classes includes receiving new data; receiving support data, wherein the support data is a subset of previously classified data; processing with a first set of layers of a deep learning classifier the new data and the support data to obtain a learned representation of the new data and the support data; and applying a second set of layers of the deep learning classifier to the learned representation to associate the new data with a corresponding class.

### CROSS-REFERENCE TO RELATED APPLICATIONS

This application claims priority to U.S. Provisional Patent Application No. 62/651,384, filed on Apr. 2, 2018, entitled “SUPPORTNET: A NOVEL INCREMENTAL LEARNING FRAMEWORK THROUGH DEEP LEARNING AND SUPPORT DATA,” the disclosure of which is incorporated herein by reference in its entirety.

### BACKGROUND

### Technical Field

Embodiments of the subject matter disclosed herein generally relate to deep learning systems and methods, and more specifically, to solving the catastrophic forgetting associated with the deep learning systems.

### Discussion of the Background

Deep learning has achieved great success in various fields. However, despite its impressive achievements, there are still several problems that plague the efficiency and reliability of the deep learning systems.

One of these problems is catastrophic forgetting, which means that a well-trained deep learning model tends to completely forget all the previously learned information when learning new information. In other words, once a current deep learning model is trained to perform a specific task, it cannot be easily re-trained to perform a new, similar, task without negatively impacting the original task's performance. Unlike human and animals, the deep learning models do not have the ability to continuously learn over time and from different datasets, by incorporating new information while retaining the previously learned experience, which is known as “incremental learning.”

Two theories have been proposed to explain human's ability to perform incremental learning. The first theory is Hebbian learning with homeostatic plasticity, which suggests that human brain's plasticity will decrease as people learn more knowledge to protect the previously learned information. The second theory is the complementary learning system (CLS) theory, which suggests that human beings extract high-level structural information and store the high-level information in a different brain area while retaining episodic memories.

Inspired by these two neurophysiological theories, researchers have proposed a number of methods to deal with deep learning catastrophic forgetting. The most straight-forward and pragmatic method to avoid catastrophic forgetting is to retrain a deep learning model completely from scratch with all the old data and new data. However, this method is proved to be very inefficient due to the large amount of training that is necessary each time new information is available. Moreover, the new model that learns from scratch the new information and the old one may share very low similarity with the previous model, which results in poor learning robustness.

In addition to this straightforward method, there are three categories of methods that deal with this matter. The first category is the regularization approach, which is inspired by the plasticity theory. The core idea of such methods is to incorporate the plasticity information of the neural network model into the loss function to prevent the parameters from varying significantly when learning new information. These approaches are proved to be able to protect the consolidated knowledge [1]. However, due to the fixed size of the neural network, there is a trade-off between the performance of the old and new tasks [1]. The second class uses dynamic neural network architectures. To accommodate the new knowledge, these methods dynamically allocate neural resources or retrain the model with an increasing number of neurons or layers. Intuitively, these approaches can prevent catastrophic forgetting but may also lead to scalability and generalization issues due to the increasing complexity of the network. The last category utilizes the dual-memory learning system, which is inspired by the CLS theory. Most of these systems either use dual weights or take advantage of pseudo-rehearsal, which draw training samples from a generative model and replay them to the model when training with new data. However, how to build an effective generative model remains a difficult problem.

Thus, there is a need for a new deep learning model that is capable of learning new information while not being affected by the catastrophic forgetting problem. Further, the system needs to be robust and practical when implemented in real life situations.

### SUMMARY

According to an embodiment, there is a method for classifying data into classes, and the method includes receiving new data, receiving support data, wherein the support data is a subset of previously classified data, processing with a first set of layers of a deep learning classifier the new data and the support data to obtain a learned representation of the new data and the support data, and applying a second set of layers of the deep learning classifier to the learned representation to associate the new data with a corresponding class.

According to another embodiment, there is a classifying apparatus for classifying data into classes, and the classifying apparatus includes an interface for receiving new data and receiving support data, wherein the support data is a subset of previously classified data, and a deep learning classifier connected to the interface and configured to, process with a first set of layers the new data and the support data to obtain a learned representation of the new data and the support data, and apply a second set of layers to the learned representation to associate the new data with a corresponding class.

According to yet another embodiment, there is a method for generating support data for a deep learning classifier, the method including receiving data, processing with a first set of layers of the deep learning classifier the received data to obtain a learned representation of the received data, and training a support vector machine block with the learned representation to generate support data. The support data is used by the deep learning classifier to prevent catastrophic forgetting when classifying data.

According to still another embodiment, there is a classifying apparatus for classifying data into classes, and the classifying apparatus includes an interface for receiving data, and a processor connected to the interface and configured to, process with a first set of layers of a deep learning classifier the received data to obtain a learned representation of the received data, and train a support vector machine block with the learned representation to generate support data. The support data is used by the deep learning classifier to prevent catastrophic forgetting when classifying data.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a schematic illustration of a deep learning-based apparatus that is capable of class incremental learning;

FIG. 2 illustrates various blocks of a classification apparatus that prevents catastrophic forgetting;

FIG. 3 illustrates how support data is generated for the classification apparatus to prevent the catastrophic forgetting;

FIG. 4A illustrates a deep learning model that uses a residual block while FIG. 4B illustrates a modified deep learning model that uses channel information;

FIG. 5 illustrates the influence of a regularizer on the learned parameters of the deep learning model;

FIG. 6 is a flowchart of a method for generating the support data;

FIG. 7 is a flowchart of a method for classifying data based on the generated support data;

FIGS. 8A to 8F illustrate the efficiency and accuracy of a novel classifying method for various datasets, when compared with existing methods;

FIG. 9 illustrates the accuracy of the novel classifying method comparative to another method for a new task;

FIGS. 10A and 10B illustrate the accuracy deviation of the novel classifying method with respect to another method when the support data size is modified;

FIG. 11 is a flowchart of a method for classifying data based on support data;

FIG. 12 is a flowchart of a method for generating the support data; and

FIG. 13 is a schematic diagram of a computing device that implements the novel methods for classifying data.

### DETAILED DESCRIPTION

The following description of the embodiments refers to the accompanying drawings. The same reference numbers in different drawings identify the same or similar elements. The following detailed description does not limit the invention. Instead, the scope of the invention is defined by the appended claims.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an embodiment, a novel method for performing incremental deep learning in an efficient way with a deep learning model when encountering data from new classes is now discussed. The method and model maintain a support dataset for each old class, which is much smaller than the original dataset of that class, and show the support datasets to the deep learning model every time there is a new class coming in so that the model can “review” the representatives of the old classes while learning the new information. Although the broad idea of rehearsal has been suggested before [2, 3, 4, 5], the present method selects, in a novel way, the support data, such that the selection process becomes systematic and generic to preserve as much information as possible. As discussed later, it will be shown that it is more efficient to select support vectors of a support-vector machine (SVM), which is used to approximate the neural network's last layer, as the support data, both theoretically and empirically. Further, the network is divided into two parts, the first part including the last layer and the second part including all the previous layers. This is implemented to stabilize the learned representation of old data before being fed to the last layer and to retain the performance for the old classes, following the idea of the Hebbian learning theory. Two consolidation regularizes are used to reduce the plasticity of the deep learning model and constrain the deep learning model to produce similar representations for the old data.

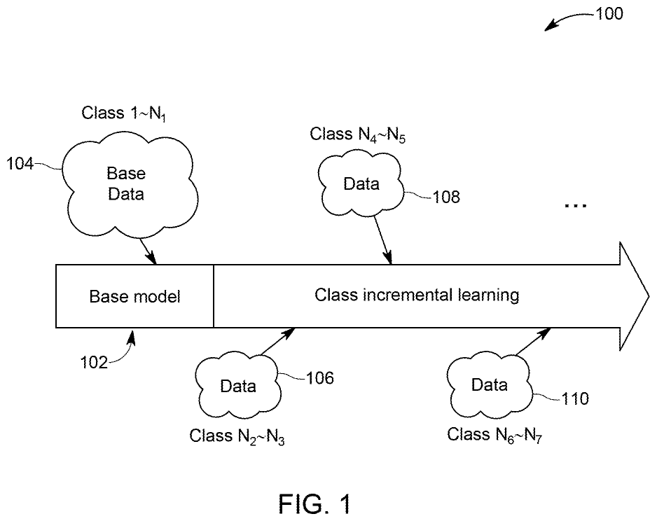

Schematically, this new model 100 is illustrated in FIG. 1, in which a base model 102 is initially trained with a base data set 104. However, new data 106, 108, and 110 belonging to new classes may continuously appear and the model is capable, for the reasons next discussed, to handle the new classes without experiencing catastrophic forgetting. As noted above, a support dataset for each old class needs to be selected. This means, that when new data is available, the novel model is not trained based on (1) all the old data and (2) all the new data, but only on (i) selected data from the old data and (ii) all the new data. Selecting data associated with the old data, i.e., the support data, is implemented in a novel way in this embodiment. This selection is now discussed in more detail.

Following the setting of [6, 7], consider a dataset {xₙ, ŷₙ}ₙ₌₁^{N}, with xₙ∈ [symbol] ^{D} being the feature, and ŷₙ∈ [symbol] ^{K} being the one-hot encoding of the label, K is the total number of classes of information and N is the size of the dataset. The input (i.e., the learned representation) to the last layer is denoted as δₙ∈ [symbol] ^{T} for xₙ and W is considered to be the parameter of the last layer so that zₙ=Wδₙ. After applying softmax activation function to zₙ, the output oₙ of the whole deep learning model (i.e., neural network) is obtained for the input xₙ. Thus, the following equation holds for this model:

$${o}_{n , i} = \frac{exp ( {z}_{n , i} )}{{\sum }_{k = 1}^{K} exp ( {z}_{n , i} )} = \frac{exp ( {W}_{i , :} {δ}_{n} )}{{\sum }_{k = 1}^{K} exp ( {W}_{k , :} {δ}_{n} )} . \qquad ( 1 )$$

For the deep learning model, the cross-entropy loss is used as the loss function, i.e.,

$$L = - \frac{1}{N} {\sum }_{n = 1}^{N} {\sum }_{k = 1}^{K} {\tilde{y}}_{n , k} log ( {o}_{n , k} ) . \qquad ( 2 )$$

The negative gradient of the loss function L with regard to w_{j,i} is given by:

$$- \frac{\partial L}{\partial {w}_{j , i}} = \frac{1}{N} {\sum }_{n = 1}^{N} ( {\tilde{y}}_{n , i} - {o}_{n , i} ) {δ}_{n , j} = \frac{1}{N} {\sum }_{n = 1}^{N} ( {\tilde{y}}_{n , i} - \frac{exp ( {W}_{i , :} {δ}_{n} )}{{\sum }_{k = 1}^{K} exp ( {W}_{k , :} {δ}_{n} )} ) {δ}_{n , j} . \qquad ( 3 )$$

According to [6] and [7], after the learned representation of the deep learning model becomes stable, the last weight layer will converge to the SVM solution. This means that it is possible to write W=a(t)Ŵ+B(t), where Ŵ is the corresponding SVM solution, t represents the t-th iteration of the algorithm, a(t)→∞, and B(t) is bounded. Thus, equation (3) becomes:

$$- \frac{\partial L}{\partial {w}_{j , i}} = \frac{1}{N} {\sum }_{n = 1}^{N} ( {\tilde{y}}_{n , i} - \frac{exp ( a ( t ) {\hat{W}}_{i , :} {δ}_{n} ) exp ( {B ( t )}_{i , :} {δ}_{n} )}{{\sum }_{k = 1}^{K} exp ( a ( t ) {\hat{W}}_{k , :} {δ}_{n} ) exp ( {B ( t )}_{k , :} {δ}_{n} )} ) {δ}_{n , j} . \qquad ( 4 )$$

The candidate value of \tilde{y}_{n,i} is {0, 1}. If \tilde{y}_{n,i}=0, that term of equation (4) does not contribute to the loss function L. Only when \tilde{y}_{n,i}=1, the data contributes to the loss L and thus, to the gradient. Under these conditions, because a(t)→∞, only the data with the smallest exponential nominator can contribute to the gradient. That data are the ones having the smallest margin Ŵ_{i,:}δₙ, which are the support vectors for class i. Based on these observations, it is discussed next how to select data from the old data to construct the support data.

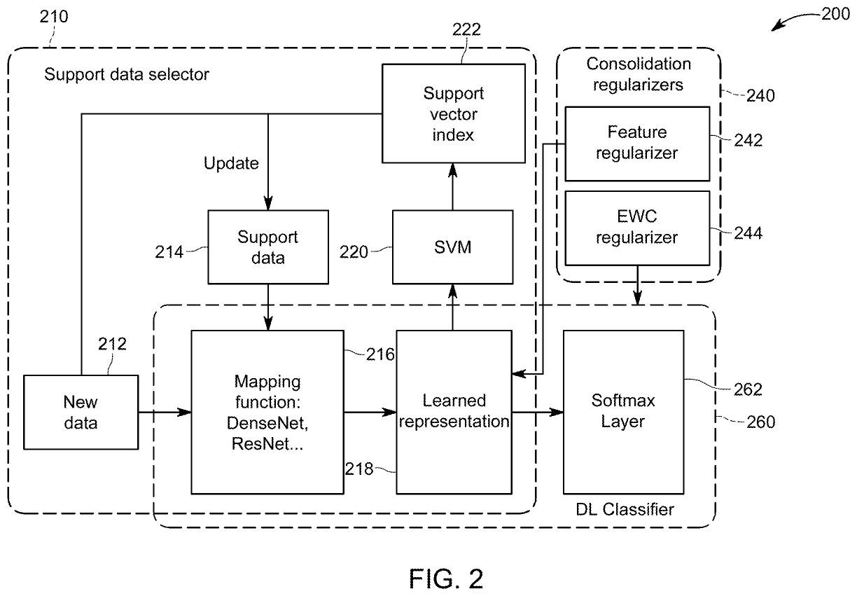

FIG. 2 schematically illustrates the logical blocks of the novel deep learning model as implemented in a classification apparatus 200. As shown in this figure, there is a support data selector block 210, a consolidation regularizers block 240, and a deep learning classifier block 260. The support data selector block 210 uses new data 212 and support data 214 at a mapping function block 216. In this implementation, the mapping function block 216 represents all the layers but the final layer of the deep learning model. In other words, the layers that form the deep learning model are split into a first set of layers and a second set of layers. In this embodiment, the first set of layers 216 includes all the layers but the last one. The second set of layers includes only the last layer 262. The support data 214 is extracted from the old data that was used to train the classifier apparatus 200, while the new data 212 is brand new data that was never before fed to the apparatus 200. The mapping function block 216 uses the new data and the support data to extract one or more features of the data. The mapping function block 216 may use a deep learning model to extract the high-level features from the input data. These features are part of the learned representation 218 that is produced by the mapping function block 216. From the learned representation 218, the SVM unit 220 generates the support vectors and also generates a support vector index 222, which is provided to and constitutes part of the support data 214.

The softmax layer 262, which is the last layer of the deep learning model, uses the learned representation 218 to classify the data that is input to the apparatus 200. The consolidation regularizers block 240, as discussed later, stabilizes the deep learning network and maintains the high-level feature representation of the old information.

Returning to the process of building the support data 214, it is noted that according to [8] and [9], even human beings, who are proficient in incremental learning, cannot deal with catastrophic forgetting perfectly. On the other hand, a common strategy for human beings to overcome forgetting during learning is to review the old knowledge frequently [10]. Actually, during reviewing, the humans do not usually review all the details, but rather the important ones, which are often enough for humans to grasp the knowledge. Inspired by this real-life example, the novel method maintains a support dataset 214 for each old class, which is then fed to the mapping function block 216 together with the new data 212 of the new classes. In this way, the mapping function block 216 reviews the representative information of the old classes when learning new information.

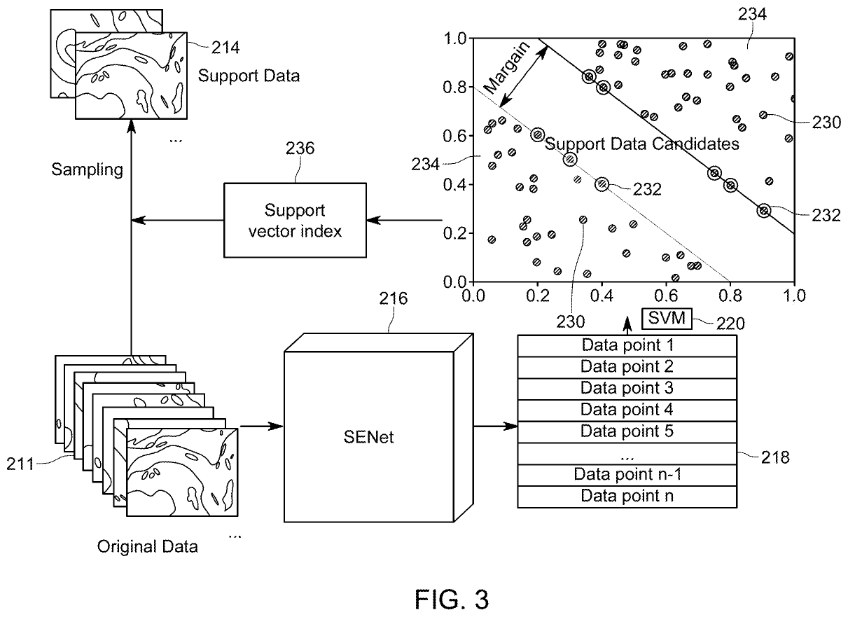

The configuration of the support data selector 210 that constructs such support data 214 is now discussed. The support data 214 is assumed to be described by {xₙ^{S}, \tilde{y}ₙ^{S}}ₙ₌₁^{N}^{_{S}} and it shown in FIG. 3. According to the discussion with regard to equation (4), the data corresponding to the support vectors for the SVM solution contributes most to the deep learning model training. Based on this observation, the high-level feature representations 218 are obtained for the new data 212 and the support data 214, using the deep learning mapping function block 216. FIG. 3 shows a specific implementation of the deep learning mapping function block 216 that uses SENet [11]. Other feature extractors may be used, as for example, ResNet [12], ResNext [13], and GoogLeNet [14].

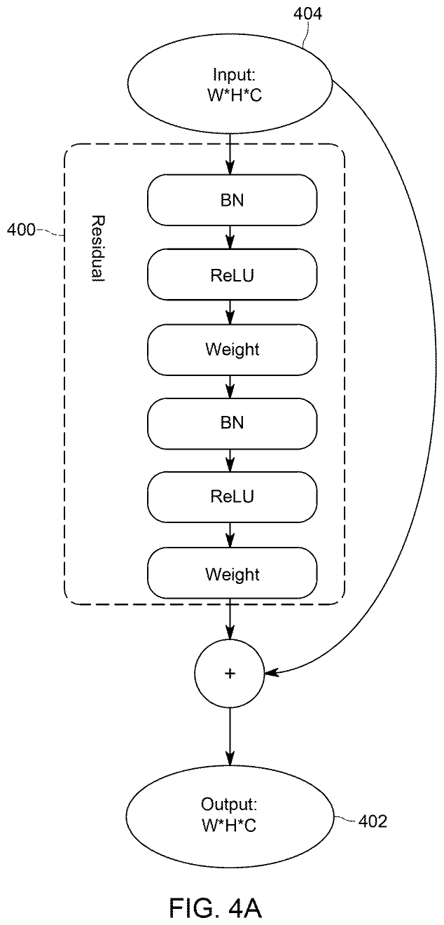

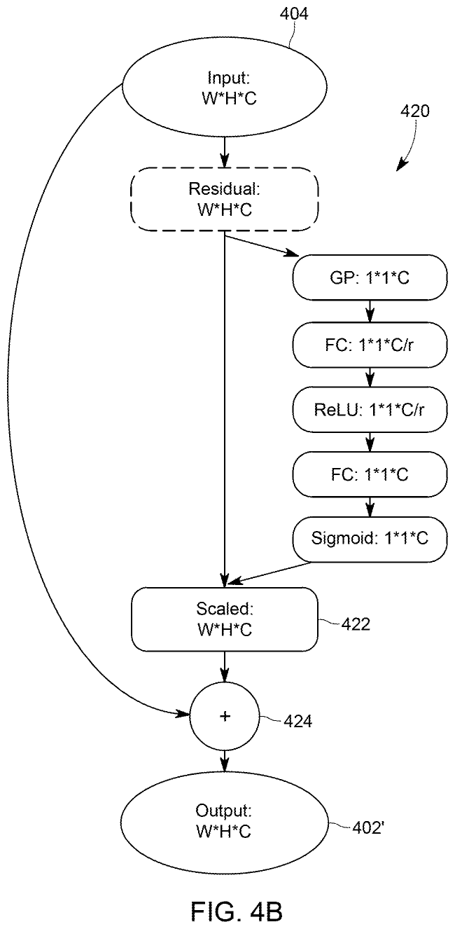

The SENet is configured to utilize the spatial information with 2D filters, and further explores the information hidden in different channels by learning weighted feature maps from the initial convolutional output. The residual network utilizes a traditional convolutional layer within a residual block 400, as shown in FIG. 4A, which consists of the convolutional layer and a shortcut of the input, to model the residual between the output feature maps 402 and the input feature maps 404. Despite the impressive performance of the residual block 400, it cannot explore the relation between different channels of the convolutional layer output.

To overcome this issue, the SENet modifies the residual block with additional components which learn scale factors for different channels of the intermediate output and rescale the values of those channels accordingly. Intuitively, the traditional residual network treats different channels equally while the SENet takes the weighted channels into consideration. Using the SENet as the engine for the mapping function block 216, which considers both the spatial information and the channel information, it is more likely to obtain a good structured high-level representation 218 (402′ in FIG. 4B) of the original input data, which is necessary for the support data selection block 210 and the downstream deep learning classification block 260.

FIG. 4B illustrates the main difference between the residual block 400 and the SENet block 420. In this regard, note that for the residual block 400, the input feature maps 404, with dimensionality as W (weight) by H (height) by C (channels), go through two ‘BN’ (batch normalization) layers, two ‘ReLU’ activation layers and two ‘weight’ (linear convolution) layers. The output of these six layers is added to the original input feature maps element-wise to obtain the residual block output feature maps 402. The SENet block 420 extends the residual block by considering the channel information. After obtaining the residual layer output, it does not add the output directly to the original input. Instead, it learns a scaling factor 422 for each channel and scales the channels accordingly, after which the scaled feature maps are added at adder 424 to the input 404, element-by-element, to obtain the SENet block output 402′. To learn the scale vector, the SENet block first applies a ‘GP’ (global average pooling) layer onto the residual layer output, whose dimensionality is W by H by C, to obtain a vector with length C. After that, two ‘FC’ (fully connected) layers with ReLU and Sigmoid activation functions are used respectively to learn the final scaling vector. The hyper-parameter ‘r’, which determines the number of nodes in the first fully connected layer, is usually set as 16. Other values may be used for this parameter. By considering both the spatial information and the channel information comprehensively, the SENet is more likely to learn a better high-level representation of the original input [11]. Note that the parameters of the GP layer and FC layers in the SENet block 420 are restricted by the new loss function that is discussed later with regard to equation (10).

Returning to FIG. 3, the SVM block 220 is then trained with the high-level representations 218, which results in many support vectors 230 and 232. The high-level representations 218 are generated by the mapping function block 216 from the original data 211. Note that the original data 211 is considered herein to be the first data that is used for training the deep learning classifier 260 or a combination of new data and already generated support data. After performing the SVM training, the method selects only those support vectors 232 that are on the border of the various classifications 234 shown in FIG. 3. According to this embodiment, only the border support vectors 232 are considered to contribute to the support data 214, and not the other vectors 230. These support vectors 232 are then indexed to form the support data index 236.

The portion of the original data 211 which correspond to these support vectors is then selected as being the support data 214, which is denoted herein as {xₙ^{SV}, \tilde{y}ₙ^{SV}}ₙ₌₁^{N}^{_{SV}}. If the required number of support data candidates 232 is smaller than that of the support vectors, the algorithm will sample the support data candidates to obtain the required number. Formally, this can be written as:

{xₙ^{S}, \tilde{y}ₙ^{S}}ₙ₌₁^{N}^{_{S}}⊂{xₙ^{SV}, \tilde{y}ₙ^{SV}}ₙ₌₁^{N}^{_{SV}}. (5)

If the new data 212 is denoted as being {xₙ^{new}, \tilde{y}ₙ^{new}}ₙ₌₁^{N}^{_{new}}, then the new training data for the model is described by:

{xₙ^{S}, \tilde{y}ₙ^{S}}ₙ₌₁^{N}^{_{S}}∪{xₙ^{new}, \tilde{y}ₙ^{new}}ₙ₌₁^{N}^{_{new}}. (6)

Because the support data selection depends on the high-level representation 218 produced by the deep learning layers, which are finetuned on new data 212, the old data feature representations 214 may change over time. As a result, the previous support vectors 232 for the old data may no longer be support vectors for the new data, which makes the support data invalid (here it is assumed that the support vectors will remain the same as long as the representations are largely fixed, which will be discussed in more details later). To solve this issue, the novel method adds two consolidation regularizers to consolidate the learned knowledge: (1) the feature regularizer 242, which forces the model to produce fixed representations for the old data over time, and (2) the EWC regularizer 244, which consolidates the weights that contribute to the old class classification to the loss function. Each of these two regularizers are now discussed in detail. Note that these regularizers apply only to the mapping function block 216 and not to the softmax layer 262 (i.e., only to the first set of layers and not to the second set of layers of the deep learning model).

The feature regularizer, which will be added to the loss function, forces the mapping function block 216 to produce a fixed representation for the old data. The learned representation, which was denoted above as δₙ depends on ϕ, which represents the parameters of the deep learning mapping function block 216. The feature regularizer is defined as:

$${R}_{f} ( φ ) = {\sum }_{n = 1}^{{N}_{S}} {‖ {δ}_{n} ( {φ}_{new} ) - {δ}_{n} ( {φ}_{old} ) ‖}_{2}^{2} , \qquad ( 7 )$$

where ϕ_{new} is the parameters for the deep learning architecture trained with (1) the support data from the old classes and (2) the new data from the new class(es), ϕ_{old} is the parameters for the mapping function of the old data, and Nₛ is the number of support data 214.

The feature regularizer 242 requires the model to preserve the feature representation produced by the deep learning architecture for each support data, which could lead to potential memory overhead. However, because the model operates on a very high-level representation 218, which is of much less dimensionality than the original input 211, the possible overhead is neglectable.

The second regularizer is the EWC regularizer 244. According to the Hebbian learning theory, after learning, the related synaptic strength and connectivity are enhanced while the degree of plasticity decreases to protect the learned knowledge. Guided by this neurophysiological theory, the EWC regularizer [15] was designed to consolidate the old information while learning new knowledge. One goal of the EWC regularizer is to constrain those parameters (in the mapping function block 216) which contribute significantly to the classification of the old data. Specifically, the more a parameter contributes to the previous classification, the harder a constrain is applied to that parameter to make it unlikely to be changed. That is, the method makes those parameters that are closely related to the previous classification less “plastic.” In order to achieve this goal, the Fisher information is calculated for each parameter. The Fisher information measures the contribution of the parameters to the final prediction.

Formally, the Fisher information for the parameters θ={ϕ, W} can be calculated as follows:

$$F ( θ ) = E [ {( \frac{\partial }{\partial θ} log f ( X ; θ ) )}^{2} \vert θ ] = \int {( \frac{\partial }{\partial θ} log f ( x ; θ ) )}^{2} f ( x ; θ ) dx , \qquad ( 8 )$$

where f(x; θ) is the functional mapping used by the mapping function block 216 of the entire neural network.

The EWC regularizer 244 is defined as follows:

$${R}_{ewc} ( θ ) = {\sum }_{i} F ( {θ}_{{old}_{i}} ) {( {θ}_{{new}_{i}} - {θ}_{{old}_{i}} )}^{2} , \qquad ( 9 )$$

where i iterates over all the parameters of the model.

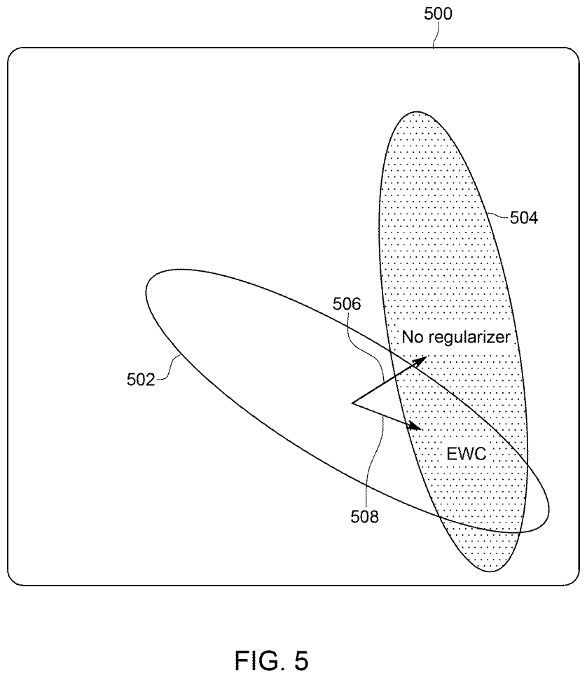

There are two benefits of using the EWC regularizer in the present method. First, the EWC regularizer reduces the “plasticity” of the parameters that are important to the old classes and thus, it guarantees stable performance over the old classes. Second, by reducing the capacity of the deep learning model, the EWC regularizer prevents overfitting to a certain degree. The function of the EWC regularizer could be considered as changing the learning trajectory, by pointing to a region where the loss is low for both the old and new data. This idea is schematically illustrated in FIG. 5. In the parameter space 500, the parameter set 502, which has low errors for the old data, and the parameter set 504, which has low errors for the new data, are not the same. However, often these parameter sets overlap, as shown in FIG. 5, because the old and new data are related. If no regularizer is added, or only the traditional L1 or L2 regularizer is used, which does not have the capability of retaining old information, the learned parameters are likely to move along direction 506 to the region 504 that is good for the new data, and thus the error is high for the old data. In contrast, the EWC regularizer 244 would push the learning to the overlapping region, along direction 508.

The two regularizers 242 and 244 are added to the loss function L of equation (2) so that the new loss function used in this method becomes:

\tilde{L}(θ)=L+λ_{f}R_{f}(ϕ)+λ_{ewc}R_{ewc}(θ), (10)

where λ_{f} and λ_{ewc} are the coefficients for the feature regularizer and the EWC regularizer, respectively. After plugging equations (2), (7), and (9) into equation (10), the following novel loss function is obtained:

$$\tilde{L} ( θ ) = - \frac{1}{{N}_{S} + {N}_{new}} {\sum }_{n = 1}^{{N}_{S} + {N}_{new}} {\sum }_{k = 1}^{{K}_{t}} {\tilde{y}}_{n , k} log ( {o}_{n , k} ) + {\sum }_{n = 1}^{{N}_{S}} {‖ {δ}_{n} ( {φ}_{new} ) - {δ}_{n} ( {φ}_{old} ) ‖}_{2}^{2} + {\sum }_{i} {{λ}_{ewc} ( {θ}_{{new}_{i}} - {θ}_{{old}_{i}} )}^{2} \int {( \frac{\partial }{\partial θ} log f ( x ; {θ}_{{old}_{i}} ) )}^{2} f ( x ; {θ}_{{old}_{i}} ) dx , \qquad ( 11 )$$

where Kₜ is the total number of classes at the incremental learning time point t (see FIG. 1).

Combining the deep learning model, which consists of the deep learning architecture mapping function block 216 and the final fully connected classification layer block 260, the novel support data selector 210, and the two consolidation regularizers 240 together, the present method is a highly effective framework (called SupportNet in the following), which can perform class incremental learning without catastrophic forgetting. This framework can resolve the catastrophic forgetting issue in two ways. Firstly, the support data 214 can help the model of the mapping function block 216 to review the old information during future training. Despite the small size of the support data 214, they can preserve the distribution of the old data quite well. Secondly, the two consolidation regularizers 242 and 244 consolidate the high-level representation 218 of the old data and reduce the plasticity of those weights, which are important for the old classes.

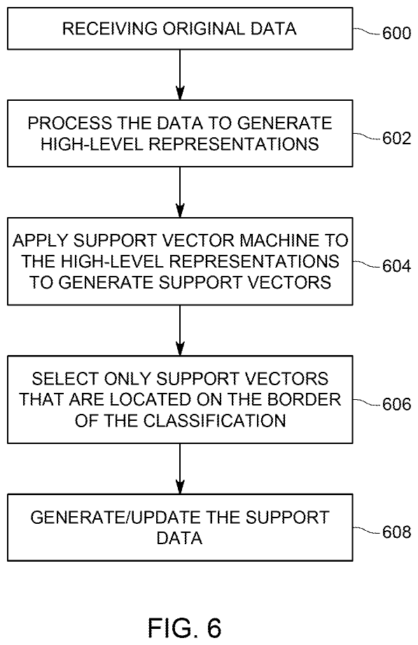

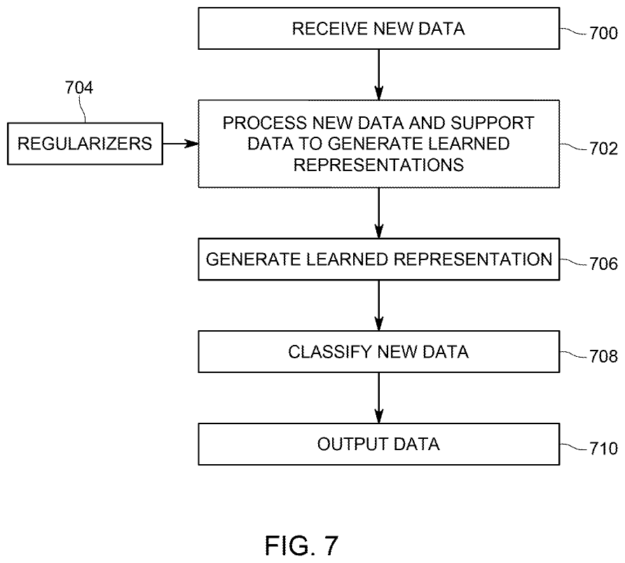

The novel method discussed above for avoiding catastrophic forgetting in class incremental learning when implemented in a computing device is now discussed with regard to FIGS. 6 and 7. FIG. 6 illustrates how the support data 214 is generated while FIG. 7 illustrates how the data (old and new) is classified. The method for generating the support data starts in step 600 by receiving the original data 211, which needs to be classified. Note that the original data 211 could be the first data ever received by the deep learning classifier apparatus 200, or new data later received, or both the new data currently received and old data previously received. The original data 211 is fed to the apparatus 200, having the logical blocks illustrated in FIG. 2. In step 602, the support data selector 210 processes the original data 211 (see FIG. 3) with the mapping function block 216 to generate one or more high-level representations of this data. Note that FIG. 3 shows a particular implementation of the mapping function block 216 as the SENet. However, other algorithms may be used for this purpose. Also note that the mapping function block 216 includes all the layers of a deep learning model, before the last layer, while block 262 in FIG. 2 represents the last layer. Thus, the support data selector 210 uses all but the last layer of the deep learning model while the deep learning classifier block 260 uses all the layers of the deep learning model.

The result of the processing step 602 with the mapping function 216 is the high-level representations 218 shown in FIG. 3. As a simple example, if the original data 211 includes images of a person, the high-level representation 218 corresponds to, for example, the eye color of that person. This simplistic example is produced to illustrate the application of this method.

In step 604, the SVM model 220 is applied to the high-level representations 218 for generating the support vectors 230. In step 606, only the support vectors 232 which are located on the edge (border) of the various classifications of the data are selected to contribute to the support data 214. These support vectors 232 are indexed to form the support vector index 236 and then, in step 608, the data associated with these vectors is extracted from the original data 211 and assembled as the support data 214. The support data 214 is much smaller in size than the original data 211, but it is still representative for all the classifications associated with the original data 211. Note that if there is already a support data collection, step 608 updates the existing support data so that the new data found in the initial data 211 finds its way into the updated support data so that catastrophic forgetting is prevented.

Having the support data, the method illustrated in FIG. 7 classifies new information while maintaining the existing information and performing all these operations in a reasonable amount of time. The method starts in step 700 in which new data 212 is received as illustrated in FIG. 2. The deep learning classifier 260 processes in step 702 both the new data 212 and the existing support data 214 to generate the learned representation 218. Note that the support data 214 describes the prior data that was used for classification. As discussed above with regard to FIG. 6, the support data 214 includes less data than the original data used for generating the older classifications. As also discussed above, the mapping function block 216 includes all but the last layer of the deep learning classifier 260. One or more of these layers have parameters that are constrained by the modified loss function disclosed in equation (11). Thus, the parameters of the mapping function block 216 are effectively constrained by the modified loss function. The loss function is modified by the consolidation regularizers 240 discussed above. This means that in step 704, the one or more regularizers 242 and 244 are applied to the mapping function block 216. In step 706, a learned representation 218 is generated and this learned representation is used in step 708 by the last layer 262 of the deep learning classifier (e.g., the softmax layer, which is a generalized form of logistic regression which can be used in multi-class classification problems where the classes are mutually exclusive) to classify the new data. In step 710, the classified data is output and, for example, displayed on a screen. Note that the layers and processes discussed herein required intensive computational power and thus, they are implemented on a computing device that is discussed later. The novel features discussed herein are implemented in the various layers of the deep learning classifier 260 and/or in the novel support data selector block 210, and/or into the consolidation regularizers 240. Thus, the novel features are implemented in a classification apparatus 200 that uses a deep learning model for classifying new data into classes.

The novel classification apparatus 200 has been tested on seven datasets: (1) MNIST, (2) CIFAR-10 and CIFAR-100, (3) Enzyme function data, (4) HeLa, (5) BreakHis and (6) tiny ImageNet. MNIST, CIFAR-10 and CIFAR-100 are commonly used benchmark datasets in the computer vision field. MNIST consists of 70K 28*28 single channel images belonging to 10 classes. CIFAR-10 contains 60K 32*32 RGB images belonging to 10 classes, while CIFAR-100 is composed of the same images but the images are further classified into 100 classes.

The latter three datasets are from bioinformatics. Enzyme function data is composed of 22,168 low-homologous enzyme sequences belonging to 6 classes. The HeLa dataset contains around 700 512*384 gray-scale images for subcellular structures in HeLa cells belonging to 10 classes. BreakHis is composed of 9,109 microscopic images of the breast tumor tissue belonging to 8 classes. Each image is a 3-channel RGB image, whose dimensionality is 700 by 460. Tiny ImageNet is similar to ImageNet, but it is much harder than ImageNet since it has 200 classes while within each class, there are only 500 training images and 50 testing images.

The tests compared the methods discussed with regard to FIGS. 6 and 7 with numerous existing methods. The first method is called herein the “All Data” method. When data from a new class appears, this method trains a deep learning model from scratch for multi-class classification, using all the new and old data. It can be expected that this method should have the highest classification performance. The second method is the iCaRL method, which is considered to be the state-of-the-art method for class incremental learning in computer vision field. The third method is EWC. The fourth method is the “Fine Tune” method, in which only the new data was used to tune the model, without using any old data or regularizers. The fifth method is the baseline “Random Guess” method, which assigns the label of each test data sample randomly without using any model. In addition, the tests also compared the results generated by a number of recently proposed state-of-the-art methods, including three versions of Variational Continual Learning (VCL) methods, Deep Generative Replay (DGR), Gradient Episodic Memory (GEM), and Incremental Moment Matching (IMM) on MNIST. In terms of the deep learning architecture, for the enzyme function data, the same architecture was used as in Li et al. [16]. As for the other datasets, the residual network was used with 32 layers. Regarding the SVM in SupportNet framework, based on the result from Li et al. [6], Soudry et al. [17], a linear kernel was used.

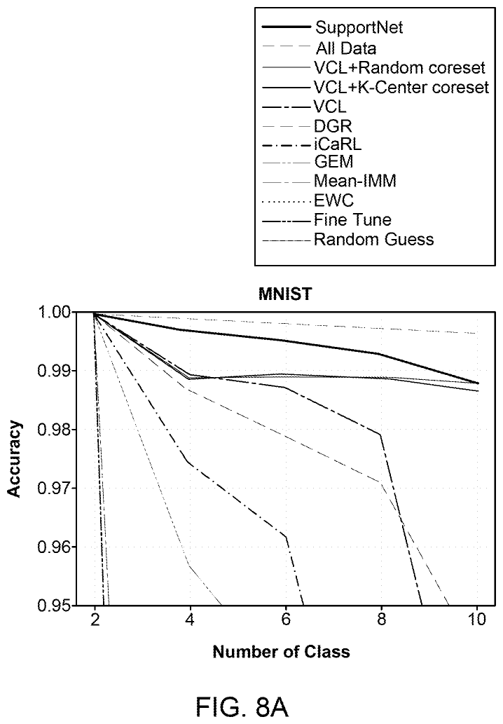

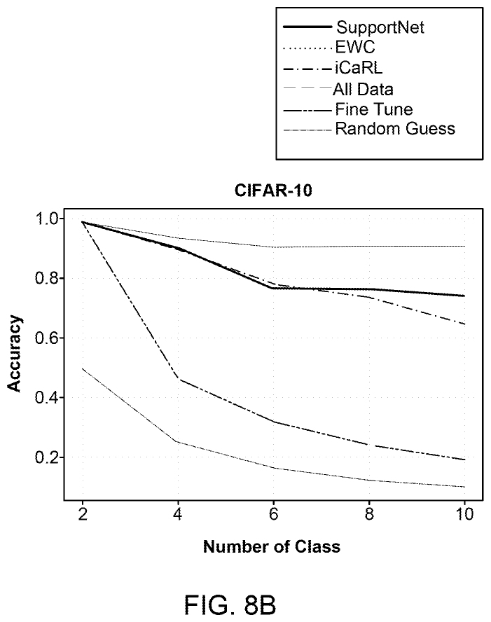

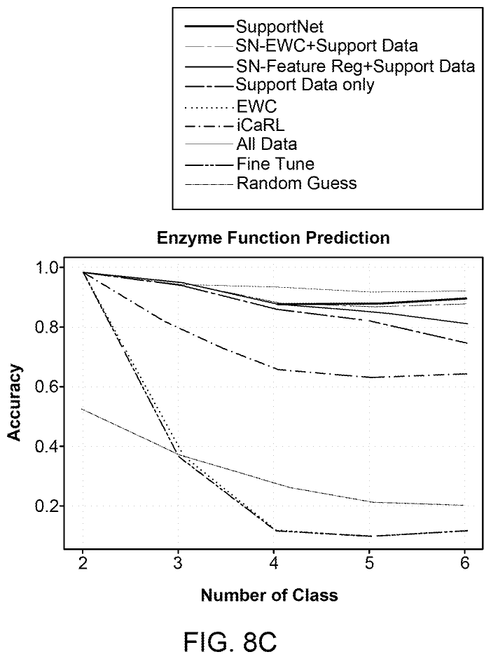

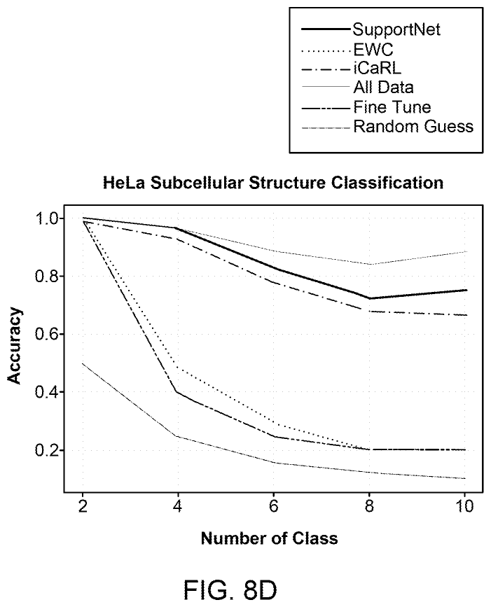

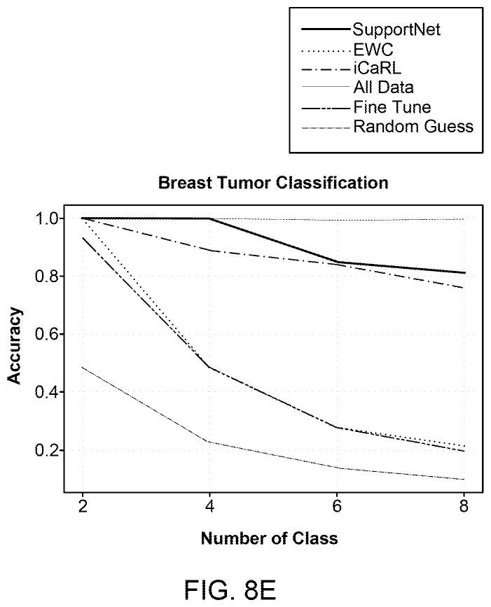

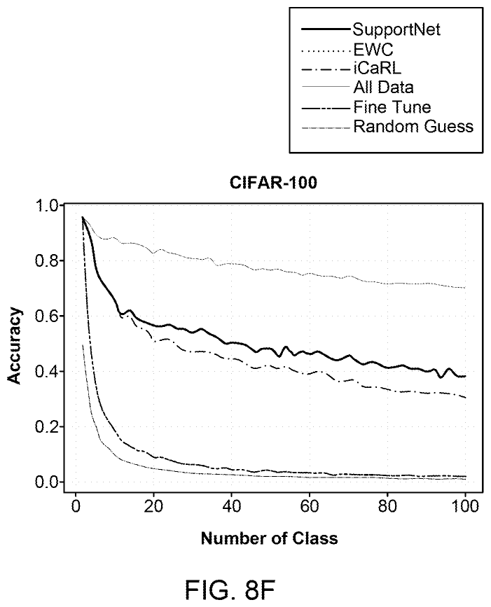

For all the tasks, the experiment started with a binary classification. Then, each time the experiment incrementally gave data from one or two new classes to each method, until all the classes were fed to the model. For the enzyme data, the experiment fed one class each time. For the other five datasets, the experiment fed two classes in each round. FIGS. 8A to 8F shows the accuracy comparison on the multi-class classification performance of the different methods, over the six datasets, along the incremental learning process.

As expected, the “All Data” method has the best classification performance because it has access to all the data and retrains a brand new model each time. The performance of this “All Data” method can be considered as the empirical upper bound of the performance of the incremental learning methods. All the other incremental learning methods have performance decrease relative to the “All Data” method with different degrees. EWC and “Fine Tune” have quite similar performance, which drops quickly when the number of classes increases. The iCaRL method is much more robust than these two methods.

In contrast, SupportNet has significantly better performance than all the other incremental learning methods across the five datasets. In fact, its performance is quite close to the “All Data” method and stays stable when the number of classes increases for the MNIST and enzyme datasets. On the MNIST dataset, VCL with K-center Coreset can also achieve very impressive performance. Nevertheless, SupportNet can outperform it along the process. Specifically, the performance of SupportNet has less than 1% on MNIST and 5% on enzyme data difference compared to that of the “All Data” method. These figures also show the importance of SupportNet's components. As shown in FIG. 8C, all the three components (support data, EWC regularizer and feature regularizer) contribute to the performance of SupportNet to different degrees. Notice that even with only support data, SupportNet can already outperform iCaRL, which shows the effectiveness of the novel support data selector 210.

Although the novel SupportNet method has been discussed with regard to class incremental learning, SupportNet can be easily adopted to perform other incremental learning tasks, such as the split MNIST task. In this task, a method needs to deal with a sequence of similar tasks which are related to each other. More specifically, the method needs to perform five binary classifications tasks in sequential order with a single model. The SupportNet method was modified for this task and then compared with four state-of-the-art methods: VCL, VCL with K-center Coreset, GEM and iCaRL. Notice that VCL-related methods are very recent state-of-the-art methods. The results show that SupportNet can also achieve state-of-the-art performance on this task, although it was originally designed to perform class incremental learning. Compared to the other methods, SupportNet can achieve higher performance on the new task while with little compromise on the older tasks. This experiment suggests the potential of SupportNet to combat catastrophic forgetting as a whole.

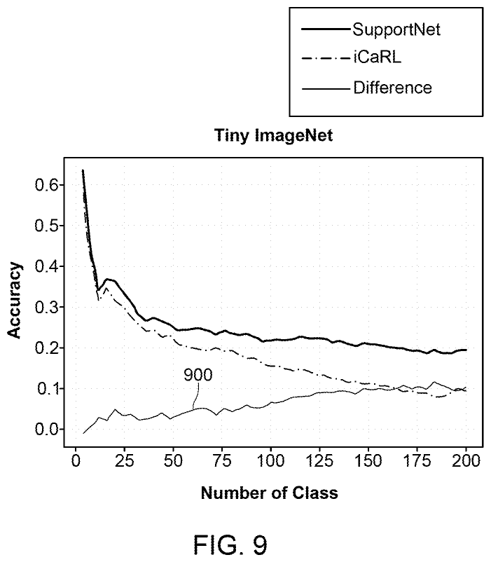

To further evaluate SupportNet's performance on class incremental learning setting with more classes, it was tested on tiny ImageNet dataset, and compared with iCaRL. The performance of Support-Net and iCaRL on this dataset is shown in FIG. 9. As illustrated in the figure, SupportNet can outperform iCaRL significantly on this dataset. Furthermore, as suggested by line 900, which shows the performance difference between SupportNet and iCaRL, SupportNet's performance superiority is increasingly significant as the class incremental learning setting goes further. This phenomenon demonstrates the effectiveness of SupportNet in combating catastrophic forgetting.

Next, the performance of SupportNet was investigated with reduced support data. Experiments were run for the SupportNet method with the support data size as small as 2000, 1500, 1000, 500, and 200, respectively. The results indicated that even with 500 support data points, the SupportNet method can outperform iCaRL with 2000 data points, which further demonstrates the effectiveness of the support data selecting strategy.

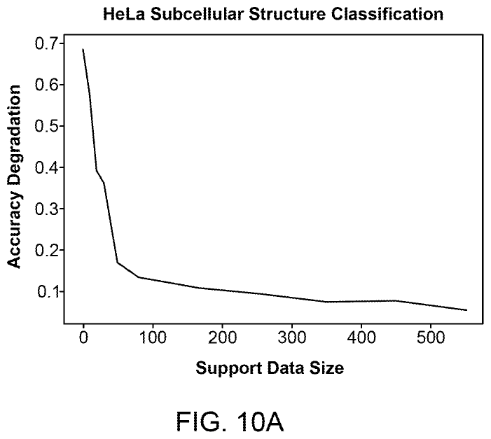

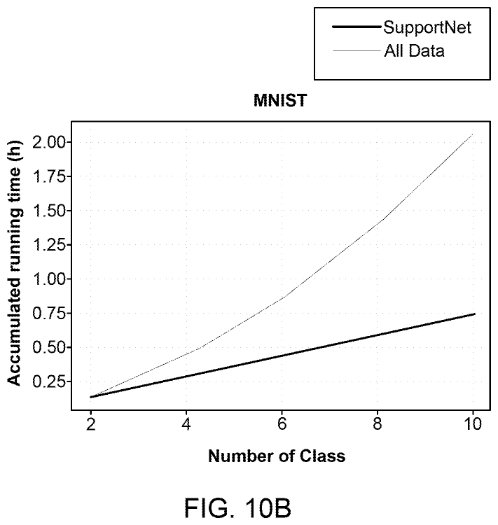

Then, the performance of the SupportNet method was investigated in terms of the impact of the support data size when compared with another dataset. As shown in FIG. 10A, the performance degradation of SupportNet from the “All Data” method decreases gradually as the support data size increases, which is consistent with the previous study using the rehearsal method. It is noted that the performance degradation decreases very quickly at the beginning of the curve, so the performance loss is already very small with a small number of support data. That trend demonstrates the effectiveness of the novel support data selector 210, i.e., being able to select a small sample of representative support dataset. On the other hand, this decent property of the novel method is very useful when the users need to trade off the performance with the computational resources and running time. As shown in FIG. 10B, on MNIST, the SupportNet method outperforms the “All Data” method significantly regarding the accumulated running time, with only less than 1% performance deviation, trained on the same hardware (GTX 1080 Ti).

All these experiments show that the proposed novel class incremental learning method, SupportNet, solves the catastrophic forgetting problem by combining the strength of deep learning and SVM. SupportNet can efficiently identify the important information associated with the old data, which is fed to the deep learning model together with the new data for further training so that the model can review the essential information of the old data when learning the new information. With the help of two powerful consolidation regularizers, the support data can effectively help the deep learning model prevent the catastrophic forgetting issue, eliminate the necessity of retraining the model from scratch, and maintain a stable learned representation that corresponds to the old and the new data.

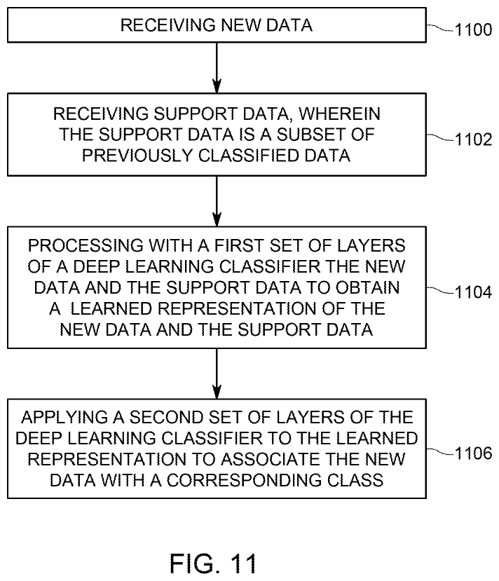

A method for classifying data into classes based on the embodiments discussed above is now presented. The method includes, as shown in FIG. 11, a step of receiving new data 212, a step 1102 of receiving support data 214, wherein the support data 214 is a subset of previously classified data 211, a step 1104 of processing with a first set of layers 216 of a deep learning classifier 260 the new data 212 and the support data 214 to obtain a learned representation 218 of the new data and the support data, and a step 1106 of applying a second set of layers 262 of the deep learning classifier 260 to the learned representation 218 to associate the new data 212 with a corresponding class. In one application, the first set of layers includes all but a last layer of the deep learning classifier and the second set of layers includes only the last layer of the deep learning classifier.

In one application, the method further includes constraining parameters of the first set of layers with a loss function, and/or adding to the loss function first and second regularizers, wherein the first regularizer is different from the second regularizer. The first regularizer depends on parameters of the first set of layers. The second regularizer uses Fisher information for each parameter of the first set of layers. The method may further include feeding the learned representation to a support vector machine block for generating vectors, and/or selecting only the support vectors that lie on a border of a classification, and/or selecting data from the new data and support data that corresponds to the support vectors and updating the support data with the selected data.

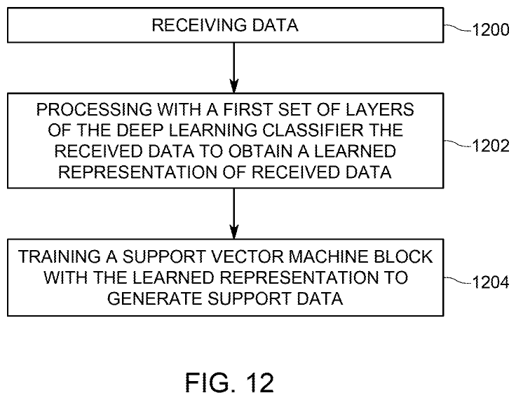

In another embodiment, as illustrated in FIG. 12, there is a method for generating support data for a deep learning classifier 260. The method includes a step 1200 of receiving data 211, a step 1202 of processing with a first set of layers 216 of the deep learning classifier 260 the received data 211 to obtain a learned representation 218 of the received data, and a step 1204 of training a support vector machine block 220 with the learned representation 218 to generate support data 214. The support data 214 is used by the deep learning classifier 260 to prevent catastrophic forgetting when classifying data. The method may further include a step of generating plural support vectors 230 based on the learned representation, and/or a step of selecting only those support vectors 232 that lie on a border between classifications, and/or a step of collecting from the received data, only support candidate data that is associated with selected support vectors to create the support data.

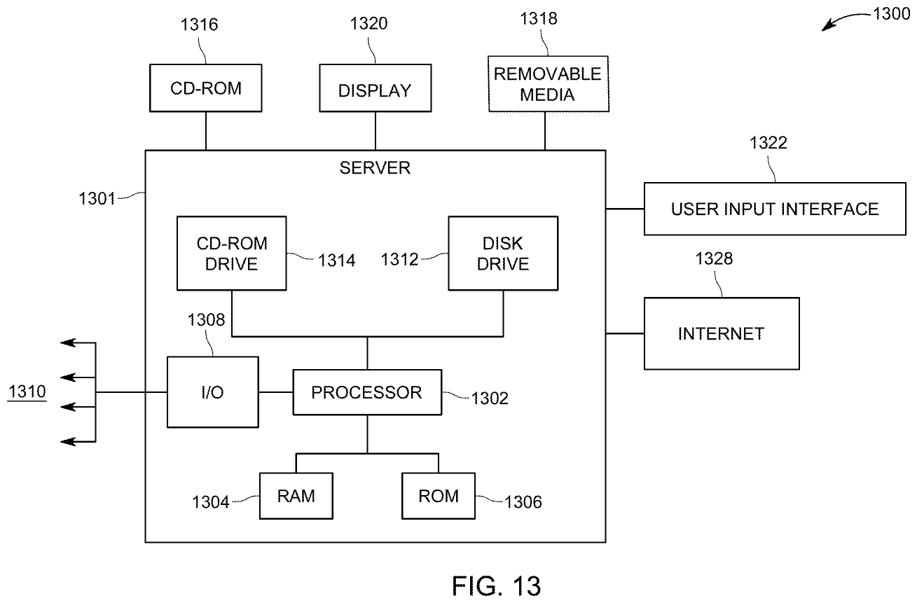

The above-discussed procedures and methods may be implemented in a computing device or controller as illustrated in FIG. 13. Hardware, firmware, software or a combination thereof may be used to perform the various steps and operations described herein. Computing device 1300 (which can be apparatus 200) of FIG. 13 is an exemplary computing structure that may be used in connection with such a system.

Exemplary computing device 1300 suitable for performing the activities described in the exemplary embodiments may include a server 1301. Such a server 1301 may include a central processor (CPU) 1302 coupled to a random access memory (RAM) 1304 and to a read-only memory (ROM) 1306. ROM 1306 may also be other types of storage media to store programs, such as programmable ROM (PROM), erasable PROM (EPROM), etc. Processor 1302 may communicate with other internal and external components through input/output (I/O) circuitry 1308 and bussing 1310 to provide control signals and the like. Processor 1302 carries out a variety of functions as are known in the art, as dictated by software and/or firmware instructions.

Server 1301 may also include one or more data storage devices, including hard drives 1312, CD-ROM drives 1314 and other hardware capable of reading and/or storing information, such as DVD, etc. In one embodiment, software for carrying out the above-discussed steps may be stored and distributed on a CD-ROM or DVD 1316, a USB storage device 1318 or other form of media capable of portably storing information. These storage media may be inserted into, and read by, devices such as CD-ROM drive 1314, disk drive 1312, etc. Server 1301 may be coupled to a display 1320, which may be any type of known display or presentation screen, such as LCD, plasma display, cathode ray tube (CRT), etc. A user input interface 1322 is provided, including one or more user interface mechanisms such as a mouse, keyboard, microphone, touchpad, touch screen, voice-recognition system, etc.

Server 1301 may be coupled to other devices, such as a smart device, e.g., a phone, tv set, computer, etc. The server may be part of a larger network configuration as in a global area network (GAN) such as the Internet 1328, which allows ultimate connection to various landline and/or mobile computing devices.

The disclosed embodiments provide methods and a classifying apparatus that can classify new information without experiencing catastrophic forgetting. It should be understood that this description is not intended to limit the invention. On the contrary, the embodiments are intended to cover alternatives, modifications and equivalents, which are included in the spirit and scope of the invention as defined by the appended claims. Further, in the detailed description of the embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

### REFERENCES

[1] Ronald Kemker, Angelina Abitino, Marc McClure, and Christopher Kanan. 2017. Measuring Catastrophic Forgetting in Neural Networks. CoRR abs/1708.02072 (2017). arXiv:1708.02072 http://arxiv.org/abs/1708.02072;

[2] David Lopez-Paz and Marc'Aurelio Ranzato. 2017. Gradient Episodic Memory for Continuum Learning. CoRR abs/1706.08840 (2017). arXiv:1706.08840 http://arxiv.org/abs/1706.08840;

[3] Cuong V. Nguyen, Yingzhen Li, Thang D. Bui, and Richard E. Turner. 2018. Variational Continual Learning. In International Conference on Learning Representations;

[4] Sylvestre-Alvise Rebuffi, Alexander Kolesnikov, and Christoph H. Lampert. 2016. iCaRL: Incremental Classifier and Representation Learning. CoRR abs/1611.07725 (2016). arXiv:1611.07725 http://arxiv.org/abs/1611.07725;

[5] Hanul Shin, Jung Kwon Lee, Jaehong Kim, and Jiwon Kim. 2017. Continual learning with deep generative replay. In Advances in Neural Information Processing Systems. 2990-2999;

[6] Yu Li, Lizhong Ding, and Xin Gao. 2018. On the Decision Boundary of Deep Neural Networks. arXiv preprint arXiv:1808.05385 (2018);

[7] Daniel Soudry, Elad Hoffer, and Nathan Srebro. 2017. The implicit bias of gradient descent on separable data. arXiv preprint arXiv:1710.10345 (2017);

[8] C. Pallier, S. Dehaene, J.-B. Poline, D. LeBihan, A.-M. Argenti, E. Dupoux, and J. Mehler. 2003. Brain Imaging of Language Plasticity in Adopted Adults: Can a Second Language Replace the First? Cerebral Cortex 13, 2 (2003), 155-161. https://doi.org/10.1093/cercor/13.2.155;

[9] Sylvain Sirois, Michael Spratling, Michael S. C. Thomas, Gert Westermann, Denis Mareschal, and Mark H. Johnson. 2008. Précis of Neuroconstructivism: How the Brain Constructs Cognition. Behavioral and Brain Sciences 31, 3 (2008), 321-331. https://doi.org/10.1017/50140525X0800407X;

[10] Jaap M. J. Murre and Joeri Dros. 2015. Replication and Analysis of Ebbinghaus' Forgetting Curve. PLOS ONE 10, 7 (07 2015), 1-23. https://doi.org/10.1371/journal.pone.0120644;

[11] Hu, J., Shen, L., and Sun, G. (2017). Squeeze-and-excitation networks. CoRR, abs/1709.01507;

[12] He, K. M., Zhang, X. Y., Ren, S. Q., and Sun, J. (2016). Deep residual learning for image recognition. 2016 Ieee Conference on Computer Vision and Pattern Recognition (Cpvr), pages 770-778;

[13] Xie, S., Girshick, R. B., Doll'ar, P., Tu, Z., and He, K. (2016). Aggregated residual transformations for deep neural networks. CoRR, abs/1611.05431;

[14] Szegedy, C., Liu, W., Jia, Y., Sermanet, P., Reed, S. E., Anguelov, D., Erhan, D., Vanhoucke, V., and Rabinovich, A. (2014). Going deeper with convolutions. CoRR, abs/1409.4842;

[15] James Kirkpatrick, Razvan Pascanu, Neil Rabinowitz, Joel Veness, Guillaume Desjardins, Andrei A. Rusu, Kieran Milan, John Quan, Tiago Ra-malho, Agnieszka Grabska-Barwinska, Demis Hassabis, Claudia Clopath, Dhar-shan Kumaran, and Raia Hadsell. 2017. Overcoming catastrophic forgetting in neural networks. Proceedings of the National Academy of Sciences 114, 13 (2017), 3521-3526. https://doi.org/10.1073/pnas.1611835114 arXiv:http://www.pnas.org/content/114/13/3521.full.pdf;

1. A method for classifying data into classes, the method comprising:
receiving new data;
receiving support data, wherein the support data is a subset of previously classified data;
processing with a first set of layers of a deep learning classifier the new data and the support data to obtain a learned representation of the new data and the support data; and
applying a second set of layers of the deep learning classifier to the learned representation to associate the new data with a corresponding class.

2. The method of claim 1, wherein the first set of layers includes all but a last layer of the deep learning classifier.

3. The method of claim 2, wherein the second set of layers includes only the last layer of the deep learning classifier.

4. The method of claim 1, further comprising:
constraining parameters of the first set of layers with a loss function.

5. The method of claim 4, further comprising:
adding to the loss function first and second regularizers, wherein the first regularizer is different from the second regularizer.

6. The method of claim 5, wherein the first regularizer depends on parameters of the first set of layers.

7. The method of claim 6, wherein the second regularizer uses Fisher information for each parameter of the first set of layers.

8. The method of claim 1, further comprising:
feeding the learned representation to a support vector machine block for generating support vectors.

9. The method of claim 8, further comprising:
selecting only the support vectors that lie on a border of a classification.

10. The method of claim 9, further comprising:
selecting data from the new data and support data that corresponds to the support vectors and updating the support data with the selected data.

11. A classifying apparatus for classifying data into classes, the classifying apparatus comprising:
an interface for receiving new data and receiving support data, wherein the support data is a subset of previously classified data; and
a deep learning classifier connected to the interface and configured to,
process with a first set of layers the new data and the support data to obtain a learned representation of the new data and the support data; and
apply a second set of layers to the learned representation to associate the new data with a corresponding class.

12. The apparatus of claim 11, wherein the first set of layers includes all but a last layer of the deep learning classifier.

13. The apparatus of claim 12, wherein the second set of layers includes only the last layer of the deep learning classifier.

14. A method for generating support data for a deep learning classifier, the method comprising:
receiving data;
processing with a first set of layers of the deep learning classifier the received data to obtain a learned representation of the received data; and
training a support vector machine block with the learned representation to generate support data,
wherein the support data is used by the deep learning classifier to prevent catastrophic forgetting when classifying data.

15. The method of claim 14, wherein the step of training comprises:
generating plural support vectors based on the learned representation.

16. The method of claim 15, further comprising:
selecting only those support vectors that lie on a border between classifications.

17. The method of claim 16, further comprising:
collecting from the received data, only support candidate data that is associated with selected support vectors to create the support data.

18. A classifying apparatus for classifying data into classes, the classifying apparatus comprising:
an interface for receiving data; and
a processor connected to the interface and configured to,
process with a first set of layers of a deep learning classifier the received data to obtain a learned representation of the received data; and
train a support vector machine block with the learned representation to generate support data,
wherein the support data is used by the deep learning classifier to prevent catastrophic forgetting when classifying data.

19. The apparatus of claim 18, wherein the processor is further configured to:
generate plural support vectors based on the learned representation.

20. The apparatus of claim 19, wherein the processor is further configured to:
select only those support vectors that lie on a border between classifications; and
collect from the received data, only support candidate data that is associated with selected support vectors to create the support data.
